(19) United States
(12) Patent Application Publication
(10) Pub. No.: US 2016/0140637 A1
(43) Pub. Date: May 19, 2016

(54) Providing For-Pay Content Via A Web-Based Searching System

(71) Applicants: Balazs Szabo, Oberrieden (CH); Peter Werner Balsiger, Bern (CH)

(72) Inventors: Balazs Szabo, Oberrieden (CH); Peter Werner Balsiger, Bern (CH)

(73) Assignee: GOOGLE INC., Mountain View, CA (US)

(21) Appl. No.: 13/438,161

(22) Filed: Apr. 3, 2012

(51) Int. Cl. G06Q 30/06; G06F 17/30; G06Q 30/02

(52) U.S. Cl. CPC G06Q 30/0623; G06Q 30/0256; G06F 17/3053; G06F 17/30528; G06Q 30/0282

(57) ABSTRACT

A websearch system for providing content to users may include a content provider, a user account interface, and a web-based search engine module. The content provider interface may facilitate interactions with content providers for preparing for-pay content for availability via web-based searching. The user account interface may facilitate the registration of end users for receiving for-pay content via web-based searching. The web-based search engine module may receive search parameters from a user; rank respective for-pay content items based on price, user feedback regarding the for-pay content and/or the relevant content provider, and/or information related to content-related disputes; identify search results that include for-pay content items; display particular search results including at least one of the for-pay content items; and provide the user access to the particular for-pay content item; wherein the user is charged a specified price for access to the selected for-pay content item.

### TECHNICAL FIELD

The present disclosure relates generally to web-based searching and, more specifically, to systems, methods, and computer programs for providing for-pay content to users via a web-based searching system.

### BACKGROUND

A web-based search service (e.g., Internet-based search service) is generally designed to receive a search query from a user, processes the query using a search algorithm and search result ranking model, and provide the search results to the user. The search service may receive a search request from a user through a search page presented to the user via a web browser hosted on a computer. For a typical search request, the user enters one or more search terms, and may select a type of resource to be searched (e.g., web pages, images, videos, etc.). Upon receiving the search query, the search service typically directs the search query to a search engine, which identifies search results based on the query and/or the type of resource selected by the user. The search service then ranks the search results identified by the search engine (e.g., based on relevance to the search terms) using a ranking algorithm. The search service then presents representations of the ranked search results to the user via a web page. The displayed representation of each search result may include, for example, a title of a web page, a hyperlink to the web page, a “snippet” of text from the web page showing search terms in bold, the size of the web page, and a hyperlink to a cached version of the web page.

Some web-based search services are supported by advertising revenue, e.g., by running search-related advertisements alongside the regular search engine results. The search engine may charge the advertiser based on user navigation to each particular ad, e.g., on a per-click basis. Typical web-based search services provide access to free information on the web for anyone who that has an Internet connection.

### SUMMARY

In certain exemplary aspects or embodiments, a computer-implemented method of including for-pay content via web-based search results is provided. The method may include receiving one or more search parameters from a user at a processor programmed to initiate a web-based search engine; receiving search results from the web-based search engine based on the one or more search parameters, the search results including one or more for-pay content items; utilizing a search ranking algorithm to rank the search results, the search ranking algorithm ranking respective for-pay content items based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item; causing a display device to display representations of particular search results including at least one of the for-pay content items; receiving a user selection of a particular one of the for-pay content items; and providing the user access to the particular for-pay content item; wherein the user is charged a specified price for access to the particular for-pay content item.

In certain exemplary aspects or embodiments, a computer system is provided. The computer system may include computer instructions stored in non-transitory computer-readable media, and a processor programmed to access and execute the computer instructions to: receive one or more search parameters from a user at a processor programmed to receive one or more search parameters from a user at a processor programmed to initiate a web-based search engine; receive search results from the web-based search engine based on the one or more search parameters, the search results including one or more for-pay content items; utilize a search ranking algorithm to rank the search results, the search ranking algorithm ranking respective for-pay content items based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item; cause a display device to display representations of particular search results including at least one of the for-pay content items; receive a user selection of a particular one of the for-pay content items; and provide the user access to the particular for-pay content item; wherein the user is charged a specified price for access to the particular for-pay content item.

In certain exemplary aspects or embodiments, a computer-based websearch system for providing content to users includes an automated content provider interface, an automated user account interface, and an automated web-based search engine module. The automated content provider interface may be configured to facilitate interactions with one or more content providers for preparing for-pay content of the one or more content providers for availability via web-based searching. The automated user account interface may be configured to facilitate the registration of end users for receiving for-pay content via web-based searching. The automated web-based search engine module may be configured to receive one or more search parameters from a user; identify search results based on the one or more search parameters, the search results including one or more for-pay content items; rank respective for-pay content items based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item; present to the user representations of particular search results including at least one of the for-pay content items; receive a user selection of a particular for-pay content item; and provide the user access to the particular for-pay content item; wherein the user is charged a specified price for access to the particular for-pay content item.

These and other aspects, objects, features, and advantages of the exemplary embodiments will become apparent to those skilled in the art upon consideration of the following detailed description of illustrated exemplary embodiments, which include the best mode of carrying out the invention as presently perceived.

### BRIEF DESCRIPTION OF THE DRAWINGS

FIG. 1 illustrates components of an example system for providing for-pay content from content providers to end users, according to certain embodiments.

FIG. 2 illustrates an example flowchart of a general method for providing for-pay content to end users, according to certain embodiments.

FIGS. 3-7 illustrate example web page views showing example aspects of an end user registering for a for-pay-content account, identifying and selecting for-pay content to purchase, purchasing selected content, accessing the purchased content, and providing feedback regarding the purchased content, according to certain embodiments.

FIG. 8 illustrates an example method for managing disputes between end users and content providers, based on an example dispute resolution algorithm, according to certain embodiments.

### DETAILED DESCRIPTION OF EXEMPLARY EMBODIMENTS

Certain embodiments of the present invention provide methods and systems for including for-pay content in the search results of a search engine, charging users to access selected for-pay content appearing in the search results, and/or handling content-related disputes between the user and the content provider.

The system may provide a content provider interface allowing content providers to submit for-pay content to the webservice provider (e.g., Google) by providing a link or uploading the content to the webservice provider's host. The webservice provider and content provider may then cooperate to identify or generate search keywords and snippets regarding the for-pay content. For example, the content provider may generate a short summary or “abstract” of the content, and the webservice provider may extract from the abstract a “results snippet” that may be displayed to a user as a search result of a websearch.

The webservice provider may also provide a websearch service (e.g., search engine) for users to search for free and for-pay content. When the user enters search terms, the webservice provider may identify both free and for-pay content using suitable algorithms. Algorithms for ranking for-pay content search results may consider factors not typically considered for ranking free content, e.g., the price of the content, the size of the content, previous good/bad user reviews of the content, user disputes regarding the content, etc.).

The free and for-pay search results may be presented to the user in any suitable manner. For example, the webservice provider may display results snippets for a number of free search results, and a notification that relevant for-pay content has also been identified. The user may then click on the notification to reveal results snippets, and price, for a number of relevant for-pay content search results.

The webservice provider may provide a link or icon allowing the user to access the abstract corresponding to a particular results snippet, along with an option to purchase the actual for-pay content summarized by the abstract. If the user has not previously opted-in to the for-pay content system, the system guides the user through a registration process, in which user identification and payment information is collected. After registration, the for-pay content is then displayed to the user.

The system may also provide a user interface for providing feedback regarding the purchased content (e.g., good or bad feedback), and may allow the user to request a refund. Thus, the webservice provider may also provide a system for handling disputes between users and the content provider, e.g., when the user feels the content was not accurately described by the abstract, or the content is otherwise not worth the price. Dispute resolution rules may consider various factors to determine the outcome of such disputes.

### System Architecture

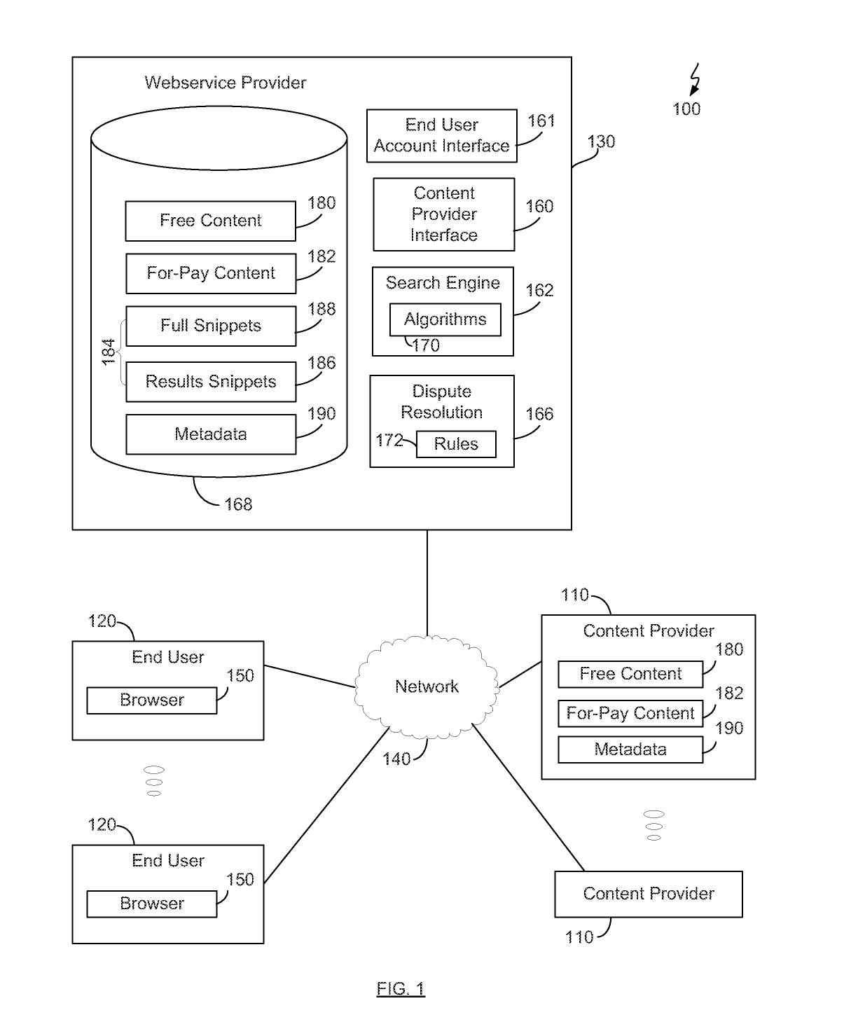

FIG. 1 illustrates components of an example system 100 for providing for-pay content from content providers to end users, according to certain embodiments. System 100 may include one or more content providers 110, one or more end users 120, and a webservice provider 130, each representing a network node configured to communicate with one another via a network 140. Network 140 may include any suitable wired and/or wireless telecommunication links by which network nodes (e.g., nodes 110, 120, and 130) can exchange data. For example, each network 140 can include one or more local area networks (“LAN”), wide area networks (“WAN”), intranets, the Internet, mobile telephone networks, and/or any combination thereof.

Each network node 110, 120, and 130 may include any number and type(s) of devices including communication devices capable of transmitting and receiving data over network 140, processors, and memory for processing and storing data (e.g., content or other data). For example, each network node 110, 120, and 130 may include any number and type(s) of servers, desktop computers, laptop computers, tablet computers, smartphones, handheld computers, personal digital assistants (“PDA”), or any other wired or wireless, processor-driven devices, or any combination thereof.

Each end user node 120 each include a browser application 150, such as Microsoft Internet Explorer, Firefox, Netscape, Google Chrome, or another suitable application for interacting with web page files maintained by webservice provider 130, content providers 110, and/or other network nodes. The web page files can include text, graphic, images, sound, video, and other multimedia or data files that can be transmitted via network 140. For example, the web page files can include one or more files in the Hypertext Markup Language (“HTML”). Browser application 150 can receive web page files from webservice provider 130 and/or content providers 110 and can display web page files to a user via end user node 120. In certain embodiments, the web page files may include information related to a web search (e.g., web pages provided by search engine module 162 of webservice provider 130), content identified by a web search (e.g., free content 180 and/or for-pay content 182 provided by webservice provider 130 and/or content providers 110), user account and settings information, and/or information related to a dispute resolution between a content provider 110 and an end user (e.g., web pages provided by dispute resolution module 166 of webservice provider 130).

Each content provider 110 may include any type or types of content to be made available to end users 120 via network 140, e.g., as search results of a web search performed by a user via browser application 150 and search engine module 162 of webservice provider 130. Particular content providers 110 may wish to make certain content available to end users for a fee, indicated as for-pay content 182, with other content available to end users for free, indicated as for-pay content 182. Each particular content provider 110 may provide free content 180, for-pay content 182, or both free content 180 and for-pay content 182. A content provider 110 may itself store some or all of its content 180/182 (e.g., using storage servers or any other suitable storage media), may transfer some or all of its content 180/182 to webservice provider 130 for storage (e.g., in storage 168 shown in FIG. 1), may use a third party for storing some or all of its content 180/182, or may store or manage the storage of its content 180/182 by any other suitable entity or in any other suitable manner. As used herein, “content” refers to text, images, audio, video, or any other form of information that can exist in a computer-based environment (or any combination thereof).

Webservice provider 130 may generally be operable to manage the identification and delivery of content 180/182 from content providers 110 to end users 120. As shown in FIG. 1, webservice provider 130 may include a content provider interface 160, an end user account interface 161, a search engine 162, a dispute resolution module 166, data storage 168, and/or any other suitable components for providing any of the functionality discussed herein. Webservice provider 130 may include any number of hosts that host various components, modules, content, or other data of webservice provider 130.

Content provider interface 160 may comprise any suitable communications interface(s) allowing communication between content providers 110 and webservice provider 130, e.g., to allow a content provider 110 to submit content 180/182 to webservice provider 130 for storage by webservice provider 130, to submit content 180/182 to webservice provider 130 to generate/negotiate “snippets,” keywords, metadata, etc. from such content, to determine/set the price of particular for-pay content 182, etc., Such interface(s) may include, for example, any suitable web-based interface or protocol (e.g., HTTP, HTTPS, or FTP) for communicating content and/or other data communications.

End user account interface 161 may be generally operable to manage account information regarding end user 120. For example, end user account interface 161 may manage the process by which end users 120 opt in and set up accounts for receiving for-pay content 182, which may be referred to as the “for-pay-content account registration process.” End users who have registered for a for-pay content account are referred to herein as “registered end users,” while end users who have not registered for a for-pay content account are referred to herein as “unregistered end users.” End user account interface 161 may also store and manage personal information (e.g., name, address, payment information, login ID, passwords, etc.) for registered end users.

Search engine module 162 may be generally operable to provide search results in response to a user-initiated query (e.g., to allow end users 120 to identify and access content 180/182 of content providers 110), allow a user to select particular search results, provide the user access to content 180/182 corresponding to selected search results, and facilitate the purchase of selected for-pay content 182. For example, search engine module 162 may be operable to receive search parameters (e.g., search terms) from an end user 120, analyze content 180/182 or metadata related to content 180/182 to identify relevant search results, rank the search results, deliver a summary of ranked search results to the end user 120 via browser 150 (e.g., by displaying “snippets” or other representations of the highest-ranked search results), and provide the end user 120 access (e.g., by links) to the full content 180/182 corresponding to search results selected by the user.

Because the available content may include both free content 180 and for-pay content 182, search engine module 162 may be configured to search and rank both free content 180 and for-pay content 182 in response to a search query, provide the end user 120 with a summary of search results including both free content 180 and for-pay content 182 (e.g., snippets of the highest-ranked free content 180 and for-pay content 182), and allow the end user 120 to access free content 180 and for-pay content 182 corresponding to user-selected search results (e.g., by providing links to such content). Webservice provider 130 may manage additional interactions with the end user 120 to allow the user to access for-pay content 182 identified in the search results, e.g., requiring the user to open an account or sign up (or “opt in”) to receive for-pay content, agree to terms of service, approve each for-pay content selection, etc., as discussed below in greater detail.

Search engine module 162 may utilize any suitable algorithms 170 for performing any of the associated functions, including for example, ranking algorithms 170 for identifying and ranking relevant content 180/182 (e.g., by analyzing corresponding metadata) and/or displaying a summary of such ranked content 180/182 to the user (via browser 150) according to one or more ranking parameters regarding the content, e.g., relevance of the content to the search terms, free content 180 vs. for-pay content 182, end user price (for for-pay content 182), user feedback ratings, etc. Such algorithms 170 may be embodied as software or any other computer-readable logic, and may be stored in any suitable memory device for access and execution by one or more processors associated with search engine 162.

Dispute resolution module 166 may be generally operable to manage disputes between end users 120 and content providers 110, e.g., regarding an end user's dissatisfaction with purchased for-pay content 182. Dispute resolution module 166 may utilize a set of dispute resolution algorithms, or rules, 172 that define various dispute management processes. Algorithms or rules 172 may be stored in any suitable memory device(s) and executable by processor(s) for providing the various functionality associated with such rules 172 as discussed herein.

Data storage 168 may store any content or data associated with services provided by webservice provider 130. For example, as shown, data storage 168 may store any of the following: free content 180 and/or for-pay content 182 submitted by content providers 110, results snippets 186 corresponding to free content 180 and/or for-pay content 182, abstracts 188 of for-pay content 182, and metadata 190 corresponding to free content 180 and/or for-pay content 182.

In some embodiments, one or more content providers 110 may submit free content 180, for-pay content 182, abstracts 188, and/or metadata 190 regarding content 180/182 to webservice provider 130, for storage by webservice provider 130 (e.g., in data storage 168) and/or for extracting or generating results snippets 186, metadata 190, and/or other data. In some embodiments, one or more content providers 110 may submit content 180/182, abstracts 188, and/or metadata 190 to webservice provider 130 for extracting or generating results snippets 186, metadata 190, and/or other data, but may manage the storage of their respective content 180/182.

Webservice provider 130 may display partial representations, e.g., short extracts or summaries, of content 180/182 to an end user 120 in response to a search query. In some embodiments, webservice provider 130 may utilize multiple types or levels of such representations for different purposes. For example, in the example embodiment shown in FIG. 1, webservice provider 130 may generate and/or utilize brief “results snippets” 186 and more extensive “abstracts” 188.

A “abstract” 188 for a particular item of for-pay content 182 is a partial representation of the content 182 that may be generally described as a short summary of the content 182, intended to act as a “teaser” to sell the full content 182 to end users 120. An abstract 188 may be manually generated by the respective content provider 110, although there may be a negotiation process or other interaction between the content provider 110 and webservice provider 130 regarding the final version of the abstract 188. Alternatively, the generation of abstracts 188 may be automatic or partially automatic, e.g., based on any suitable algorithm for analyzing the relevant content 182. Generally, the content provider may wish to prepare or control the text of the abstract to ensure that the abstract does not reveal the for-pay aspect or portion of the content 182. An abstract 188 may be any length suitable to accurate summarize the content 182, e.g., a few sentences, a paragraph, or a few paragraphs. For example, in some embodiments, a abstract 188 may be analogous to an abstract of a journal article.

In contrast, “results snippets” 186 are partial representations of content 180/182 that are typically shorter than abstracts 188. For free content 180, each results snippet 186 may be an extraction of data from the corresponding content 180, e.g., similar to snippets used in conventional search engines. For for-pay content 182, each results snippet 186 may be an extraction or summary of a corresponding abstract 188, e.g., to ensure that results snippets do not reveal for-pay content. In other embodiments, results snippet 186 may be an extraction of the for-pay content 182 itself, particularly if results snippets 186 are small, thus minimizing the risk of revealing the for-pay aspects or portions of the content 182. In some embodiments, the contractual arrangement between content providers 110 and webservice provider 130 may define whether webservice provider 130 extracts results snippets 186 from abstracts 188 or from the for-pay content 182 itself. In some embodiments, results snippets 186 for for-pay content 182 may be automatically generated by webservice provider 130, e.g., by applying an extraction algorithm to respective abstracts 188 or content 182, depending on the particular embodiment.

For instance, in one example embodiment, webservice provider 130 may display results snippets 186 for a number of free content 180 search results, and a notification that relevant for-pay content 182 has also been identified. The end user 120 may then select (e.g., click) the notification to reveal results snippets 186, and corresponding prices, for a number of relevant for-pay content 182 search results. The end user 120 may then select a particular results snippet 186 corresponding to particular for-pay content 182, upon which the corresponding abstract 186 is displayed to the end user, which may allow the end user to review a longer summary of the particular for-pay content 182 before choosing to purchase that content.

In another example embodiment, a particular results snippet 186 corresponding to particular for-pay content 182 may be displayed to an end user 120 in a set of search results (e.g., including results snippets 186 for both free content 180 and for-pay content 182), and a corresponding abstract 188 may be displayed if the end user selects the particular results snippet 186, such that the end user can review the abstract 188 before choosing to purchase that content.

Example systems and methods involving results snippets 186 and abstracts 188 are discussed below in more detail. In other embodiments, webservice provider 130 may utilize only a single type or level of partial representation of for-pay content 182 (e.g., by utilizing only results snippets 186 or only abstracts 188).

Data storage 168 may include any suitable data storage device or devices, e.g., any number and types of data servers or hard drives including any suitable types of memory, e.g., RAM, ROM, hard disk, removable media, flash memory, memory stick, optical media, magneto-optical media, CD-ROM, etc.

### General Method of Operation

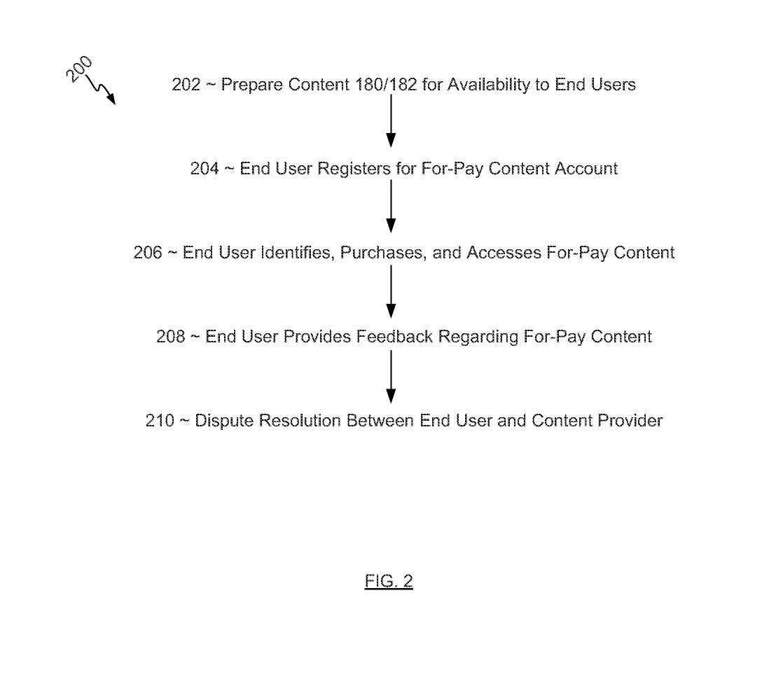

FIG. 2 illustrates an example flowchart of a general method 200 for providing for-pay content 182 to end users 120 according to certain embodiments. At step 202, content providers 110 interact with webservice provider 130 to prepare content 180/182 for availability to end users 120 via web searching, including preparing for-pay content 182 for purchase by end users 120. Such interactions may be provided or managed by content provider interface 160. Content provider interface 160 may allows content providers 110 to submit their content 180 and/or 182 and/or associated metadata 190 to webservice provider 130 by providing a link to their content or by uploading the content to one or more hosts associated with websearch provider 130. Content provider interface 160 may then extract trigger conditions (e.g., keywords, expressions, etc.), results snippets 186 (i.e., text and/or images regarding the particular content that are displayed to end users in the form of search results), etc. from the content 180/182, abstracts 188, and/or metadata 190 provided by the particular content provider 110. In some embodiments, the content provider 110 may be able to (a) change the extracted data (e.g., keywords and/or results snippets 186) via interface 160, and (b) in the case of for-pay content 182, set the price of the content. In other embodiments, the webservice provider 130 or a third party may set the price of for-pay content 182 (e.g., objectively according to predefined pricing criteria or pricing algorithms, or subjectively), or the relevant entities (e.g., content provider 110 and webservice provider 130) may negotiate the price.

In some embodiments, webservice provider 130 may check content 180/182 before includes the content in search results. For example, webservice provider 130 may check for illegal content (e.g., child pornography) or content that is not covered by the terms of service (e.g., sexual content may be excluded). As another example, webservice provider 130 may perform a “sanity check” to determine whether the content is actually what it says to be, e.g., whether the content matches the abstract 188 submitted by a content provider 110. Such functions may be performed by moderators associated with webservice provider 130 and/or may be partially or fully automated by suitable algorithms of webservice provider 130. If the content 180/182 fails any such content review, webservice provider 130 may prevent the content 180/182 from being included in search results. In some embodiments, if the content 180/182 or abstract 188 fails the such content review, the content provider 110 may be allowed to revise the content 180/182 or abstract 188 and resubmit to the webservice provider 130, which may perform a new check or series of checks on the revised content 180/182 or abstract 188, and so on, until the content 180/182 or abstract 188 are ultimately accepted or finally rejected by webservice provider 130.

As discussed above, each item of content 180/182 of a particular content provider 110 may be hosted by the content provider 110 itself, by webservice provider 130, or by a third party. Where content 180/182 is hosted by the content provider 110 itself, in some embodiments, the content provider 110 may be responsible for ensuring that particular content, in particular for-pay content 182, is rendered only for end users 120 with a valid authorization token. Token validation can be either checked at request time by a webserver of the content provider 110 calling an API at the websearch, or as an alternative, a token can be assigned by the websearch provider 130 and that can be checked locally without the need for calling an API. Alternatively, a content provider 110 may authorize websearch provider 130 to host its content, which may reduce or eliminate the need for webserver development on the content provider side.

At step 204, end users 120 interact with webservice provider 130 to complete the for-pay-content account registration process. For example, end user account interface 161 of webservice provider 130 may provide an online registration form allowing an end user 120 to create an account with the websearch provider 130 or third-party entity, including payment details and accepting terms of the service. End user account interface 161 may provide for payment in any one or suitable forms, e.g., prepaid account, credit/debit card, bank account direct withdrawal, PayPal, etc. In embodiments that provide for prepaid accounts, an end user 120 may be able to fill up his/her prepaid account as desired.

The for-pay-content account registration process may occur at any point. In some embodiment or instances, the process may occur separately from a web search process. For example, unregistered end users may be offered or notified (e.g., by webservice provider 130, content providers 110, etc.) of the opportunity to setting up a for-pay content account by email, online advertisement, or other notification or invitation. In other embodiment or instances, the for-pay-content account registration process may occur during a web search process. For instance, when an unregistered end user performs a search via browser 150, the search results page may include an indication or notification that for-pay search results are available, and provide the unregistered end user a link or other interface to set up a for-pay content account at that time, thus allowing to end user to access particular for-pay content results of the search in process. In some embodiments, the webservice provider 130 may suppress particular search results for any suitable reason. For example, due to different laws of various countries, some content might be illegal in one country but legal in another. Thus, webservice provider 130 may suppress search results that are considered illegal in the country of the end user 120 and/or the country of the webservice provider 130.

At step 206, an end user 120 may identify for-pay content 182 via web searching, purchase selected for-pay content 182, and access the purchased for-pay content 182, via browser 150 and interaction with webservice provider 130 (e.g., search engine 162). The process flow of sub-steps that comprise step 206 may take any suitable form. For example, in some embodiments, an end user 120 enters search terms or other search parameters into a search engine web page displayed at browser 150. Search engine module 162 of webservice provider 162 may execute the requested search to identify and rank search results using any suitable algorithms 170. The search results may include both free content 180 and for-pay content 182. Search engine module 162 of webservice provider 162 may then display results snippets 186 of particular search results (e.g., the highest-ranked free content 180 and for-pay content 182 search results) to the end user 120. The end user 120 may then select, based on a review of the results snippets 186 and/or corresponding abstracts 188, particular for-pay content 182 to purchase, and execute the purchase via browser 150. In some embodiments, unregistered end users may complete the for-pay-content account registration process at this time, in order to execute the purchase. Webservice provider 130 and/or the relevant content provider 110 may then provide the end user 120 access to the purchased content 182, e.g., in the form of web pages or other files.

At step 208, the end user 120 may provide feedback regarding the purchased content 182. Websearch provider 130 may provide any suitable web pages or other interfaces allowing an end user 120 to provide such feedback. For example, the interface may allow the end user to mark purchased content 182 by quality, value (e.g., based on the price), relevance to the original search terms, relevance to the snippet(s) displayed to the end user for that content 182 (e.g., results snippet 186 and/or abstract 188), or other criteria. Such ratings may be used various purposes, e.g., to inform future potential purchasers, as input into search result ranking algorithms 170 used by search engine 162, etc. In some embodiments, websearch provider 130 may provide links or interfaces allowing the end user to contact the relevant content provider 110 (e.g., to request a refund) and/or to initiate a dispute, which may be managed by dispute resolution module 166 as discussed below.

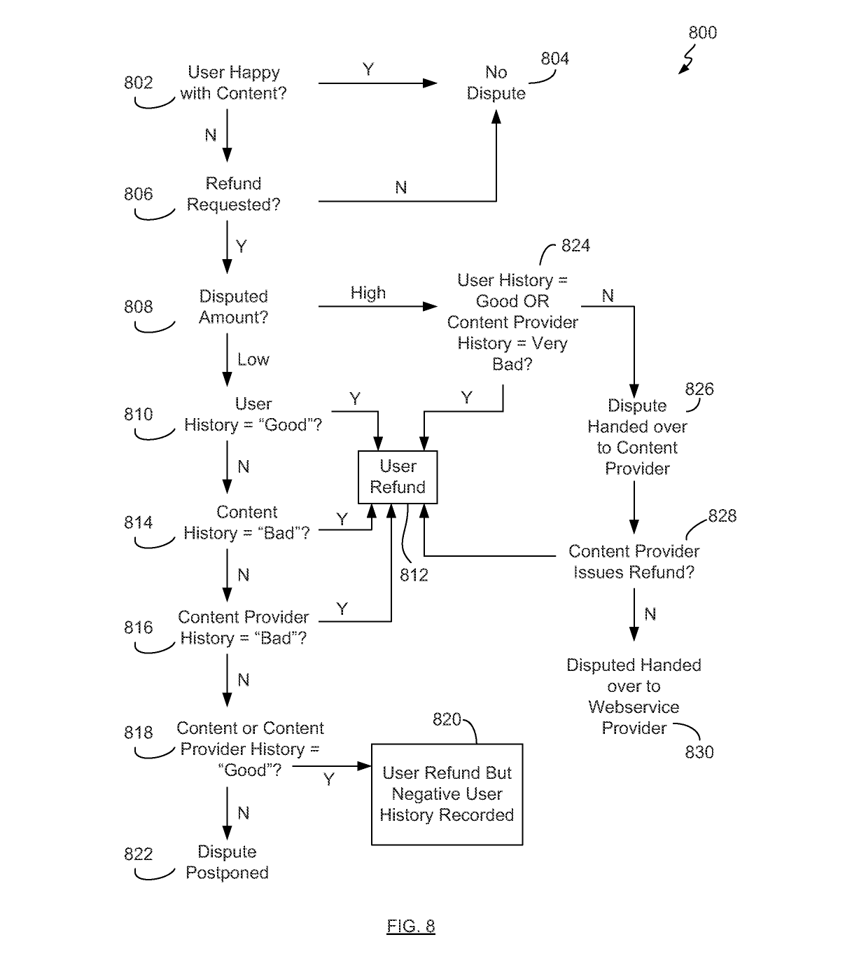

At step 210, a dispute between the end user 120 and relevant content provider 110, e.g., regarding the end user's dissatisfaction with purchased for-pay content 182, may be managed. In some embodiments, dispute resolution module 166 of websearch provider 130 may utilize dispute resolution algorithms or rules 172 that define a dispute management process. FIG. 8 describes an example dispute resolution process flow based on example dispute resolution rules 172, according to certain embodiments.

### Example Web Page Views

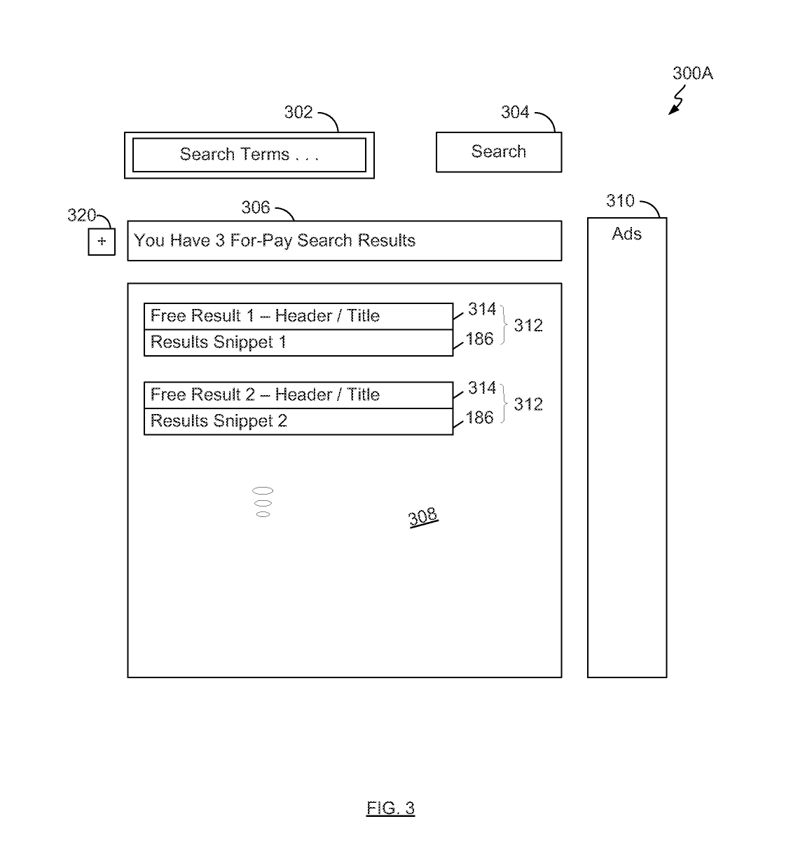

FIGS. 3-7 illustrate example web page views corresponding to steps 204 and 206 discussed above, according to certain example embodiments. In other words, the web page views show example aspects of an end user 120 registering for a for-pay-content account, identifying and selecting for-pay content 182 to purchase, purchasing selected content 182, accessing the purchased content 182, and providing feedback regarding the purchased content 182, according to certain example embodiments.

FIG. 3 illustrates an example web page view 300A displayed to an end user 120. More specifically, web page view 300A shows an example search results view resulting from the end user entering search terms into a search term field 302 and clicking a search initiation button 304, which initiates a search by search engine module 162 of webservice provider 130. As shown, the resulting view includes a for-pay search results notification 306 and a free content search results area 308. Web page 300 may also include advertisements 310 and/or other features.

Free content search results area 308 identifies a number of free content search results 312 ranked by search engine module 162 based on algorithms 170. Each free content search result 312 includes information summarizing or extracted from an item of free content 180, e.g., (a) header information 314 such as a title, URL, hotlink, etc., and (b) a results snippet 186 of the particular free content 180. As discussed above, each results snippet 186 for a free content item 180 may be an extraction of data from the corresponding content 180, e.g., similar to snippets used in conventional search engines.

Thus, free content search results area 308 may be similar to the search results page provided by certain conventional search engines.

For-pay search results notification 306 may be displayed when at least one for-pay search result, or at least one for-pay search result meeting a particular search result ranking or relevance score threshold (e.g., as determined based on algorithms 170) is identified by search engine 162; in this case, notification 306 indicates that 3 for-pay search results, or 3 for-pay search results meeting a particular ranking/score threshold, have been identified. Notification 306 may include a for-pay content search results toggle 320 (e.g., a user-clickable icon) to open a for-pay content search results area 322, e.g., by expanding the area of notification 306, opening a pop-up window, or opening a new web page.

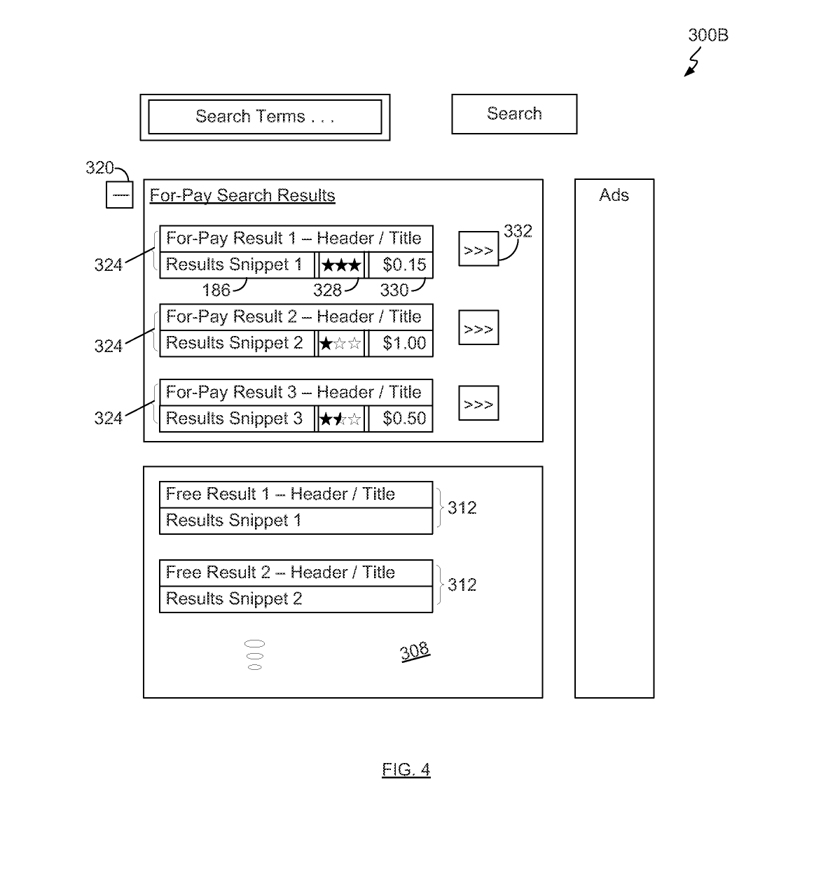

FIG. 4 illustrates an example web page view 300B after the end user has selected the for-pay content search results toggle 320 to open for-pay content search results area 322. As shown, free content search results area 308 may be automatically resized to accommodate for-pay content search results area 322. For-pay content search results area 322 identifies a number of for-pay content search results 324 ranked by search engine module 162 based on algorithms 170. In some embodiments, a maximum number of displayed for-pay content search results 324 may be defined, e.g., to ensure sufficient space for the resized free content search results area 308. In some embodiments, for-pay content search results 324 may be displayed as visually distinguishable from free content search results 312, e.g., by color, font size, font type, other visual aspect of text, or any other means of visually distinction.

Each for-pay content search result 324 includes information summarizing or extracted from an item of for-pay content 182. In this example, each for-pay content search result 324 may include (a) header information 326 such a header, title, URL, hotlink, etc., (b) a results snippet 186 of the particular for-pay content 182, (c) user feedback information 328, (d) pricing information 330, and (e) a abstract toggle 332. As discussed above, each results snippet 186 for a for-pay content item 182 may be an extraction or summary of a corresponding abstract 188 for that content 182.

User feedback summary 328 may include a summary of ratings, rankings, reviews, or other feedback previously submitted by various end users 120 regarding the for-pay content 182 identified by the respective for-pay content search result 324. In this example, feedback summary 328 comprises a star-rating review of the respective for-pay content 182. Pricing information 330 may indicate the price for accessing the for-pay content 182 identified by the respective search result 324. Finally, abstract toggle 332 may provide an interface (e.g., activated by clicking an icon, or hovering a mouse over an icon) to open a abstract area 340, e.g., by opening a pop-up window or a new web page.

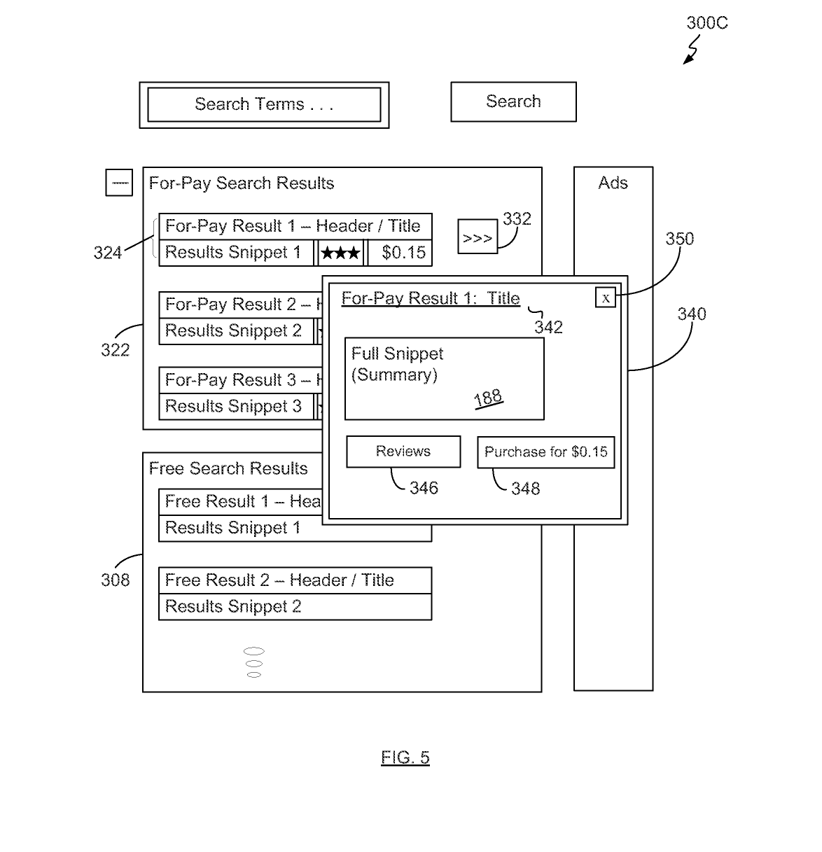

FIG. 5 illustrates an example web page view 300C after the end user has selected the abstract toggle 332 for the first-ranked for-pay search result 324, which opens a abstract area 340 corresponding to that search result 324. In this example, abstract area 340 is a pop-up window displayed over the existing web page view. Alternatively, free content search results area 308, for-pay content search results area 322, and/or other displayed features (e.g., advertisements 310) may be automatically resized to accommodate abstract area 340. Alternatively, abstract area 340 may be configured as a separate web page.

In the illustrated example, abstract window 340 may include (a) header information 342, (b) a abstract 188, (c) user feedback information 346, (d) a purchase interface 348, and (e) an interface 350 to close abstract area 340. Interface 350 may comprise a user-selectable icon (e.g., an “X” button) to close abstract area 340. Alternative, abstract window 340 may automatically close when the end user moves its mouse outside of abstract window 340. In one example embodiment, if the end user opened abstract window 340 by merely hovering over toggle icon 322 (within clicking), then interface 350 is not displayed in window 340 and window 340 automatically disappears when the end user moves the mouse off of toggle icon 322; whereas if the end user actually clicked on toggle icon 322, interface 350 is displayed in window 340 and the window is “sticky,” such that window 340 is closed only by clicking interface 350, hitting Escape, or clicking on another search result 312 or 324 (i.e., not by simply moving the mouse off of toggle icon 322).

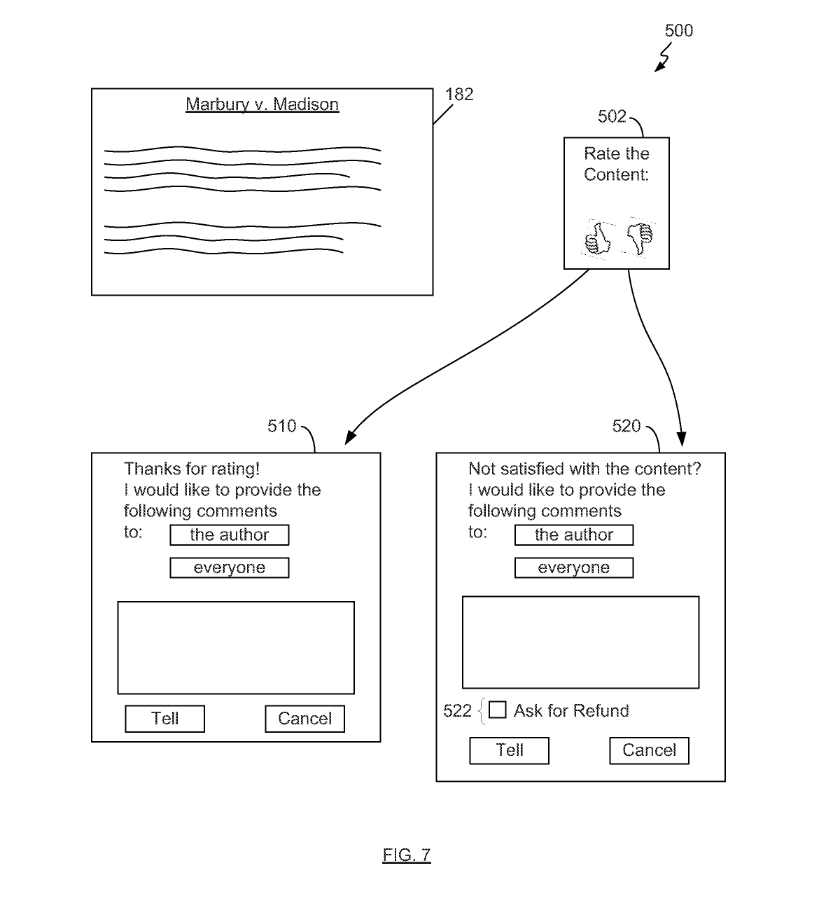

Header information 342 may be similar to header information 326, or may include additional information regarding the respective for-pay content 182, e.g., the full title, author information, date information, etc. As discussed above, the abstract 188 may be a short summary of the for-pay content item 182, manually generated by the respective content provider 110 (or alternatively, generated automatically or partially automatically, as discussed above) and intended to act as a teaser to sell the full content 182. User feedback information 346 may include or provide access to more extensive information than user feedback information 328 shown in search result 324, e.g., a link to written reviews previously submitted by end users 120 regarding the respective for-pay content 182 (or alternatively, one or more written reviews or extracts thereof may be shown directly in abstract area 340). As discussed below regarding FIG. 7, in some embodiments the relevant content provider 110 may request for particular user feedback to be deleted, e.g., where the feedback contains proprietary information or reveals aspects or portions of the for-pay content. Purchase interface 348 may provide a link to initiate a purchase process for the respective for-pay content 182 summarized by the abstract 188.

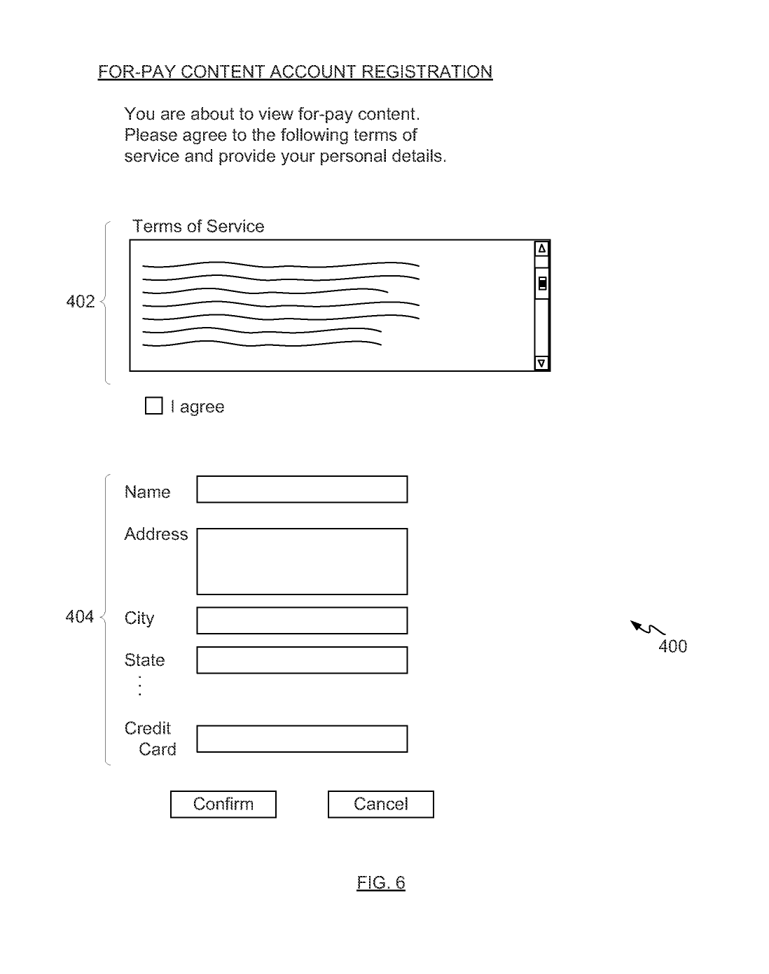

When a user attempts to purchase for-pay content 182 (e.g., by clicking on purchase interface 348), if the end user 120 is an unregistered user, end user account interface 161 may direct the user to a for-pay-content account registration process, e.g., as shown in FIG. 6, discussed below. Alternatively, if the end user 120 is already a registered user, the user may be directed to a payment confirmation page, window, or pop-up, after which confirmation the user is provided access to the selected for-pay content 182.

As an alternative to the example shown in FIGS. 3-5 in which for-pay search results 324 are displayed in a separate area from free content search results 312, in other embodiments for-pay search results 324 are displayed intermixed with free content search results 312, e.g., wherein each search result is ranked in its appropriate position. In such embodiments, for-pay search results 324 may be visually indicated as for-pay search results 324, e.g., using any suitable text, icons, coloring, etc. to distinguish from free content search results 312. This arrangement may provide users a better way of judging the relevance of for-pay content in relation to free content.

FIG. 6 illustrates an example web page view 400 for an example for-pay-content account registration process, according to certain embodiments. In the example embodiment discussed above, web page view 400 is displayed when an unregistered end user attempts to purchase for-pay content 182 (e.g., by clicking purchase interface 348 shown in FIG. 5). In addition, or in other embodiments, an end user 120 may access web page view 400 or a similar web page to register a for-pay-content account before performing a web search or at any other time.

As shown, web page view 400 may include a terms of service interface 402 and various fields 404 for personal and account details, e.g., name, address, a payment method (e.g., a credit card number, PayPal account, bank routing and account number, etc.). If the webservice provider 130 already has some or all of this data (e.g., where the end user already has one or more accounts with the webservice provider 130), then the relevant fields may be auto-populated or hidden. When the end user confirms the registration data (e.g., by clicking the “Confirm” button), a confirmation window or page may open, allowing the user to confirm all data before making a final confirmation to purchase the selected for-pay content 182. Once the end user 120 makes the final purchase confirmation, the user is provided access to the selected for-pay content 182 in any suitable manner, e.g., by automatically opening a web page, by providing link(s), be downloading files or other data to the end user 120, etc.

FIG. 7 illustrates an example web page view 500 of for-pay content 182 purchased by an end user 120. Webservice provider 130 may also display to the end user a feedback feature 502 for providing feedback for various purposes, e.g., to inform future potential purchasers (e.g., as feedback 328 or 346 discussed above), as input for search result ranking algorithms 170 for subsequent searches, to request a refund from the content provider 110, and/or to initiate a dispute with the content provider 110. As shown in FIG. 7, feedback feature 502 may comprise an interface to select positive or negative feedback, e.g., a “thumbs-up” icon for positive feedback and a “thumbs-down” icon for negative feedback. If the end user selects the positive feedback icon, a positive feedback dialog 510 opens, providing the user an interface to enter positive feedback regarding the content 182, and select whether such feedback is communicated to the content provider 110 (indicated as “author”), or to “everyone” (the content provider 110 and future potential purchasers). Similarly, if the end user selects the negative feedback icon, a negative feedback dialog 520 opens, providing the user an interface to enter negative regarding the content 182, and select whether such feedback is communicated to the content provider 110 (indicated as “author”), or to “everyone” (the content provider 110 and future potential purchasers). In addition, negative feedback dialog 520 may include a refund request option 522 allowing the end user to request a refund from the content provider 110.

The thumb-up/down interface (or any other suitable interface) for rating content may be included in the system in any suitable manner. For example, where the particular content 182 is hosted by the respective content provider 110 or a third party, the content provider 110 may include the thumb-up/down interface at the request of the webservice provider 130 (e.g., the content provider 110 includes the relevant code for the thumb-up/down interface with the content 182). As anther example, where particular content 182 is hosted by webservice provider 130, webservice provider 130 may include the thumb-up/down interface into the content 182.

In some embodiments, the relevant content provider 110 may request for particular user feedback (positive or negative) to be deleted, e.g., where the feedback contains proprietary information or reveals aspects or portions of the for-pay content. Such requests may be handled by any suitable rules or algorithms, e.g., an algorithm similar to the example dispute resolution algorithm discussed below, and may be managed by webservice provider 130 or other suitable entity.

### Dispute Resolution

FIG. 8 illustrates an example method 800 for managing disputes between end users 120 and content providers 110, based on an example dispute resolution algorithm or rules 172, according to certain embodiments. At 802, the algorithm determines whether the end user 120 is satisfied with purchased content 182. If so, there is no dispute, indicated at 804. If not, the algorithm determines at 806 whether the end user has requested a refund from the content provider, e.g., whether the user has selected the refund request option 522 in the negative feedback dialog 520 shown in FIG. 7. If not, there is no dispute, indicated at 804. If so, at 808 the algorithm determines the dollar amount in dispute (e.g., the price of the content which the user is seeking a refund).

If the disputed amount is “low,” i.e., below a predefined threshold amount, the algorithm determines at 810 whether the end user has a “good” user history rating, i.e., above a predefined threshold rating. Webservice provider 130 may maintain and manage a user history rating for each registered end user 120, which webservice provider 130 may adjust over time based on metrics associated with the end user, such as the number of disputed purchases by the user, the number of undisputed purchases by the user, the percentage of purchases disputed by the user, the results of dispute initiated by the end, violations of the webservice providers terms, etc. If it is determined at 810 that the end user has a “good” user history rating, a user refund is stipulated at 812. Alternatively, if the end user does not have a “good” user history rating, the algorithm advances to 814.

At 814, the algorithm determines whether the particular content 182 has a “bad” content feedback rating, i.e., below a predefined threshold rating. Webservice provider 130 may maintain and manage a content feedback rating for each item or unit of for-pay content 182, e.g., based on user feedback (e.g., amount or percentage of negative feedback regarding the content 182), dispute history regarding the content 182, etc. If it is determined at 814 that the particular content 182 has a “bad” content feedback rating, a user refund is stipulated at 812. Alternatively, if the particular content 182 does not have a “bad” content feedback rating, the algorithm advances to 816.

At 816, the algorithm determines whether the relevant content provider 110 has a “bad” content provider history rating, i.e., below a predefined threshold rating. Webservice provider 130 may maintain and manage a content provider history rating for each content provider, e.g., based on user feedback (e.g., amount or percentage of negative feedback regarding the content provider 110), dispute history regarding the content provider 110, etc. If it is determined at 816 that the content provider 110 has a “bad” content provider history rating, a user refund is stipulated at 812. Alternatively, if the content provider 110 does not have a “bad” content provider history rating, the algorithm advances to 818.

At 818, the algorithm determines whether the content 182 has a “good” content feedback rating (i.e., above a predefined threshold) or the content provider 110 has a “good” content provider history rating (i.e., above a predefined threshold). The thresholds for a “good” content feedback rating and a “good” content provider history rating may be above and distinct from the respective thresholds for a “bad” content feedback rating and a “bad” content provider history rating, such that a range of ratings may fall between the respective “good” and “bad” ratings (i.e., a content feedback rating or content provider history rating may fall between “good” and “bad”). If the algorithm determines that either the content 182 or the content provider 110 has a “good” rating, at 820 the algorithm stipulates a refund to the end user, but also a negative feedback event for the user, which may be incorporated into the user's user history rating (discussed above at step 810), which may affect subsequent disputes initiated by the user. Alternatively, if the algorithm determines that neither the content 182 nor the content provider 110 has a “good” rating, the dispute is postponed for some time until either one of the above criteria happens (e.g., after many disputes from other users for the same content or for the same user for other content) or a predetermined amount of time has passed. In the former situation, the algorithm may proceed as discussed above. In the latter situation, the algorithm decides the dispute in favor of the content provider 110.

Returning to step 808, if the disputed amount is “high,” i.e., above the predefined threshold amount, the algorithm determines at 824 whether either (a) the end user has a “good” user history rating (discussed above at 810) and (b) the relevant content provider 110 has a “very bad” content provider history rating, i.e., below a predefined threshold rating lower than the “bad” content provider history rating threshold discussed above at 816. If either of these conditions is met, a user refund is stipulated at 812. If neither of these conditions is met, the algorithm advances to 826.

At 826, the dispute is forwarded to the content provider 110 to review and decide how to proceed. The content provider may decide to issue a refund at 828. Otherwise, the dispute is forwarded to webservice provider 130, wherein a human may review the dispute and determine a resolution as appropriate.

It should be understood that the dispute resolution algorithm shown in FIG. 8 is an example only, and that webservice provider 130 may employ any other suitable dispute resolution algorithms or techniques.

### Ranking Algorithms

As discussed above, search engine module 162 may utilize any suitable algorithms 170 for performing any of the associated functions, including for example, ranking algorithms 170 for identifying and ranking relevant content 180/182 (e.g., by analyzing corresponding metadata) and/or displaying a summary of such ranked content 180/182 to the user (via browser 150) according to one or more ranking parameters or signals. In some embodiments, search engine module 162 may utilize the same ranking algorithm 170 for ranking free content 180 and for-pay content 182. In other embodiments, search engine module 162 may utilize different ranking algorithms 170 for ranking free content 180 and for-pay content 182. For example, the ranking algorithms 170 for ranking for-pay content 182 may consider additional factors that are not relevant to free content 180. In some embodiments, ranking of free content may be similar to conventional search ranking, e.g., by weighing various parameters or signals and then sorting according to the calculated result. However, for searching and/or ranking for-pay content 182, the following additional parameters or signals might be used: (a) price of the content 182, (b) size of the content 182, (c) content feedback rating for the content 182, or other quantification of user feedback (e.g., positive/negative), number of open disputes, and/or result of resolved disputes regarding the content 182, (d) content provider history rating for the relevant content provider 110 or other quantification of user feedback (e.g., positive/negative), number of open disputes, and/or result of resolved disputes regarding the relevant content provider 110, and/or (h) and uniqueness of the content 182 (e.g., a quantitative scoring indicating the extent to which the content 182 differs from free content 180).

The exemplary methods and systems described in this disclosure are illustrative, and, in alternative embodiments, certain steps can be performed in a different order, in parallel with one another, omitted entirely, and/or combined between different exemplary embodiments, and/or certain additional acts can be performed, without departing from the scope and spirit of this disclosure. Accordingly, such alternative embodiments are included in the inventions described herein.

The exemplary embodiments can be used with computer hardware and software that perform the methods and processing functions described above. As will be appreciated by those having ordinary skill in that art, the systems, methods, and procedures described herein can be embodied in a programmable computer, computer executable software, or digital circuitry. The software can be stored on computer readable media. For example, “computer-coded,” “software,” “scripts,” and “programs” are software codes used interchangeably for the purposes of simplicity in this disclosure. Further, “memory” and storage can include such media as, floppy disk, RAM, ROM, hard disk, removable media, flash memory, memory stick, optical media, magneto-optical media, CD-ROM, etc.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A computer-implemented method for improving search engine function in ranking and separately displaying of including for-pay content via in web-based search results, the method comprising:
receiving, at a search engine of a webservice provider computing device, one or more search parameters from a processor of a user computing device;
identifying, by the search engine, search results from the web based on the one or more search parameters, the search results comprising one or more for-pay content items and one or more free content items;
utilizing, by the search engine, a first search ranking algorithm to rank the one or more for-pay content items of the search results, the first search ranking algorithm ranking a respective for-pay content item of the one or more for-pay content items based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item;
utilizing, by the search engine, a second search ranking algorithm to rank the one or more free content items of the search results, wherein the first search ranking algorithm is different from the second search ranking algorithm;
generating, by the search engine, a first and second result snippet for display in a web-browser search results use interface, the first snippet displaying the ranked one or more for-pay content items and the second snippet display the search results for the ranked one or more free content items;
causing, by the search engine, a web search results interface of a browser application on the user computing device to display the first and second snippets.

2. The method of claim 1, further comprising facilitating a process to register the user for an account to receive for-pay content items.

3. The method of claim 1, comprising:
receiving, by the search engine, a user selection of a particular for—pay content item from the user computing device of at least one of the one or more for pay content items in the first snippet;
causing the user computer device to display the results snippet corresponding to the particular for-pay content item;
receiving a user selection of the displayed results snippet corresponding to the particular for-pay content item from the user computing device; and
in response to the user selection of the displayed results snippet, causing the user computer device to display the abstract corresponding to the particular for-pay content item, wherein the abstract comprises a more extensive summary or extract of the for-pay content item as compared to the results snippet.

4. The method of claim 1, further comprising causing the user computing device to simultaneously display representations of the at least one of the one or more for-pay content items that are ranked and the at least one of the one or more free content items that are ranked.

5. The method of claim 4, wherein displayed representations of the at least one of the one or more free content items are visually distinguished from displayed representations of the at least one of the one or more for-pay content items.

6. The method of claim 1, further comprising causing the user computer device to simultaneously display representations of the at least one of the one or more free content items and a notification that the search results include at least one for-pay content item.

7. The method of claim 6, wherein the notification that the search results include at least one for-pay content item comprises an expandable link to access representations of the at least one for-pay content item.

8. The method of claim 1, wherein the first search ranking algorithm ranks the respective for-pay content item of the one or more for-pay content items based on a quantitative measure of the uniqueness of the respective for-pay content item.

9. (canceled)

10. The method of claim 1, further comprising providing an automated interface allowing the user to request a refund for a purchased for-pay content item.

11. The method of claim 1, further comprising managing an automated dispute resolution process for a dispute between the user and the content provider regarding a purchased for-pay content item.

12. A computer system comprising:
computer instructions stored in non-transitory computer-readable media; and
a processor programmed to access and execute the computer instructions to:
receive one or more search parameters from a user computing device at a processor search engine programmed to initiate a web-based search engine;
identify by the search engine search results based on the one or more search parameters, the search results including one or more for-pay content items and one or more free content items;
utilize by the search engine a first search ranking algorithm to rank the one or more for-pay content items of the search results, the first search ranking algorithm ranking respective for-pay content items based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item;
utilize by the search engine a second search ranking algorithm to rank the one or more free content items of the search results, wherein the first search ranking algorithm is different from the second search ranking algorithm;
generate by the search engine a first and second results snippet for display in a web-browser search results users interface, the first snippet displaying the ranked one or more for-pay content items and the second snippet display the search results for the ranked one or more free content items
cause the user computer device to display a web search results user interface comprising the first and second snippets.

13. The system of claim 12, further comprising computer instructions to:
cause the user computing device to display a results snippet corresponding to the particular for-pay content item,
wherein the results snippet corresponding to the particular for-pay content item is generated based on an abstract associated with the particular for-pay content, and
wherein the abstract associated with the particular for-pay content item is generated based on a content of the for-pay content item;
receive a user selection of the displayed results snippet corresponding to the particular for-pay content item; and
in response to the user selection of the displayed results snippet, cause the user computing device to display the abstract corresponding to the particular for-pay content item, wherein the abstract comprises a more extensive summary or extract of the for-pay content item as compared to the results snippet.

14. The system of claim 13, wherein the computer instructions are executable to cause the user computing device to simultaneously display representations of at least one free content item of the one or more free content items and at least one for-pay content item of the one or more for-pay content items.

15. The system of claim 13, wherein the computer instructions are executable to cause the user computing device to simultaneously display representations of at least one free content item of the one or more free content items and a notification that the search results include at least one for-pay content item.

16. The system of claim 15, wherein the notification that the search results include at least one for-pay content item comprises an expandable link to access representations of the at least one for-pay content item of the one or more for-pay content items.

17. The system of claim 13, wherein the first search ranking algorithm ranks respective for-pay content items based on a quantitative measure of the uniqueness of the respective for-pay content item.

18. A computer-based web search system for providing content to users, the system comprising:
a storage device;
a processor communicatively coupled to the storage device, wherein the processor executes application code instructions that are stored in the storage device; and
an automated web-based search engine module installed on the storage device and configured to:
receive one or more search parameters from a user;
identify search results based on the one or more search parameters, the search results including one or more for-pay content items and one or more free content items;
rank respective for-pay content items using a first ranking algorithm based on a set of factors including at least one of: (a) a specified price of the respective for-pay content item, (b) user feedback regarding the respective for-pay content item, (c) information related to disputes concerning the respective for-pay content item, and (d) user feedback regarding a content provider regarding the respective for-pay content item;
rank the one or more free content items based on a second ranking algorithm that is different from the first ranking algorithm;
generate a first and second result snippet for display in a web-browser search results user interface on the user computing device.

19. The system of claim 18, wherein the web-based search engine module is configured to:
present to the user the first and second snippets;
receive from the user a selection of the results snippet corresponding to the particular for-pay content item; and
in response, present to the user an abstract corresponding to the particular for-pay content item, wherein the abstract comprises a more extensive summary or extract of the for-pay content item as compared to the results snippet.

20. The system of claim 19, wherein to prepare the particular for-pay content for availability via web-based searching, the automated content provider interface is configured to:
receive the abstract from a content provider associated with the particular for-pay content item; and
automatically generate the results snippet from the abstract received from the content provider.

21. The method of claim 1, further comprising:
providing a user interface to receive the user feedback associated with the particular for-pay content item to which the user is provided access;
receiving a request to delete the user feedback responsive to determining that the user feedback reveals portions of the particular for-pay content item; and
responsive to receiving the request, deleting the user feedback.

22. The method of claim 1, further comprising:
determining, by the processor, that the user has requested a refund for the purchased for-pay content item;
determining, by the processor, a rating history of the user;
determining, by the processor, a content rating associated with the purchased for-pay content;
determining, by the processor, a rating of the content provider associated with the purchased for-pay content;
determining, by the processor, a refund amount based on at least one of the rating history of the user, the content rating, and the rating of the content provider; and
updating, by the processor, the rating history of the user responsive to determining the refund amount.

23. The system of claim 12, wherein the computer instructions are executable to:
determine that the user has requested a refund for the particular for-pay content item;
determine a rating history of the user;
determine a content rating associated with the particular for-pay content;
determine a rating of the content provider associated with the particular for-pay content;
determine a refund amount based on at least one of the rating history of the user, the content rating, and the rating of the content provider; and
update the rating history of the user responsive to determining the refund amount.

24. The system of claim 18, wherein the automated content provider interface is configured to:
determine that the user has requested a refund for the particular for-pay content item;
determine a rating history of the user;
determine a content rating associated with the particular for-pay content;
determine a rating of the content provider associated with the particular for-pay content;
determine a refund amount based on at least one of the rating history of the user, the content rating, and the rating of the content provider; and
update the rating history of the user responsive to determining the refund amount.

25. The method of claim 1, further comprising:
in response to receiving a user selection for a particular pay content item from the user display device, providing, by the search engine, a user access to the selected for pay content item, wherein the user is charged a specified price for access to the particular for pay content item; and
providing, by the search engine, an automated interface for display on the display computer device allowing the user to submit user feedback regarding the particular for pay content item.
